(19) United States
(12) Patent Application Publication
(10) Pub. No.: US 2011/0284440 A1
(43) Pub. Date: Nov. 24, 2011

(54) MULTIFUNCTIONAL EQUIPMENT FOR FILTERING POOL WATER

(76) Inventor: LUIZ FILIPE DE SOUZA SISSON, TAQUARA / RS (BR)

(21) Appl. No.: 12/782,762

(22) Filed: May 19, 2010

(51) Int. Cl. E04H 4/14; C02F 1/00; C02F 1/32

(52) U.S. Cl. 210/167.12

(57) ABSTRACT

“MULTIFUNCTIONAL EQUIPMENT FOR FILTERING POOL WATER”, it consists of an equipment (1) to be used in swimming pools, composed by a box (2) with saddles to receive, immediately or later, besides main motor-pump (3), a motor-pump (4) for solar heating of the water, filter with ultraviolet light (5), register (6) for cleaning with water pressurized by the equipment itself and optional register (7) for Scottish shower, for instance, besides an armored control box (8) with external activation (A).

### BACKGROUND OF THE INVENTION

This Utility Model report refers to a new “MULTIFUNCTIONAL EQUIPMENT FOR FILTERING POOL WATER”, which deals with an equipment whose constructiveness presents saddles that allow the insertion of facilities according to needs and financial availability of the end client, adding, besides the basic function of filtering the pool water, a filter with ultraviolet ray of light, motor-pump for solar heating, armored and tight box for stowage of electronic components for lighting control and filtering of easy accessibility, representing an efficiently way to meet the end client as well as the producing process, which works with a universal box.

Residential pools are becoming more common and popular, since the production processes and equipments have reduced the cost of installation, optimizing the cost/benefit. Besides the visual appeal, the pools are used for practical exercises and as a way of leisure. Thus, the market offers swimming pools and related equipments for more various budgets.

Regardless of type, pools require some accessories and chemical products needed to keep the water clean and suitable for use. Moreover, pools are used in the warmer months of the year leaving it idle in the remaining time as well as at night.

In this sense, manufacturers of swimming pools have developed new products that enable the pool asepsis by chemical products associated to ultraviolet rays. Another very used resource is the warming of the water, by gas heating or solar heating, this latest ecologically correct. Numerous other facilities are developed to obtain maximum use of the pool, as, for instance, artificial lighting, electronic control of components and accessories, etc.

In the state of the art, filtering systems can be described by numerous patent documents as MU 8000413-0 that deals with a circulation and filtering system of pool water composed by house machine with two isolated slots interlinked by tubing. The first slot is a guard-filter that works flooded and on the same level in the pool, being linked to said pool by a tubing of great diameter, which acts as a strainer or skimmer. A tubing placed at bottom of the first slot makes the linkage with the second slot, which works dried and where is mounted the motor-pump assembly, dispensing the pre-filter, since said filter is positioned at its upstream, preventing entry of dirt inside it. The aspirated water is controlled by adequate registers to the tubing of return to the pool or to the discharge tubing in the sewer. The slots are integrated in a single house machine, with however a dividing wall between them.

MU 8400477-0 deals with a pool filter with two slots, having a lateral open along to superior edge of first slot, which creates a drain, favoring the flow of water that accumulates on said slot, and a lowed adapter of pre-filter, which disallow the parallel entrance of air in the outlet hose of filtering, having also equidistant tabs that prevent the formation of swirl in the suction region, solving problems related to the lack of efficiency in sucking the water. Another improvement relates to the installation of an escape valve in the filtering element, which opens the water passage when the filter is saturated and finally a flange with angle adjustment that allows installation in walls of sloped swimming pools, so that all the proposals represent a positive difference in the market, without any increase in manufacturing costs.

MU 8601951-1 refers to equipment for filtering of pool water with an ultraviolet ray device inserted in a box with two slots. In the first slot, there are a pre-filter, filtering element, and adapter for suction hose; in the second slot, there is a motor-pump assembly, highlighted by a device for water filtering by ultraviolet lamp.

As it can be noted, the inventor of this patent is owner of other patents that shows the evolution and facilities presented since patent registration MU 8000413-0 that keeps the machinery and its compounds inserted in two slots; MU 8400477-0 improves its use, solving operational problems as swirl, resulting in a better suction. Finally, MU 8601951-1 describes a device that uses ultraviolet ray to filter pool water without using too many chemical products.

### SUMMARY OF THE INVENTION

Aware of the state of the art and gaps in it, the inventor, a person skilled in this matter, after research and studies, created the “MULTIFUNCTIONAL EQUIPMENT FOR FILTERING POOL WATER”, which is an equipment having saddles for insertion of facilities, as motor-pump for solar heating, filter using ultraviolet lamp, optional outputs for Scottish shower and washing with pressurized water by the motor-pump. With this solution, it is possible to add the facilities gradually, according to needs and/or financial availability of the end client, besides facilitating the production and commercial process of the equipment.

### BRIEF DESCRIPTION OF THE DRAWINGS

To follow, it is explained the new “MULTIFUNCTIONAL EQUIPMENT FOR FILTERING POOL WATER”, with reference to the attached drawings, which are represented in an illustrative and not limited way:

FIG. 1: View in perspective of the multifunctional equipment for filtering pool water;

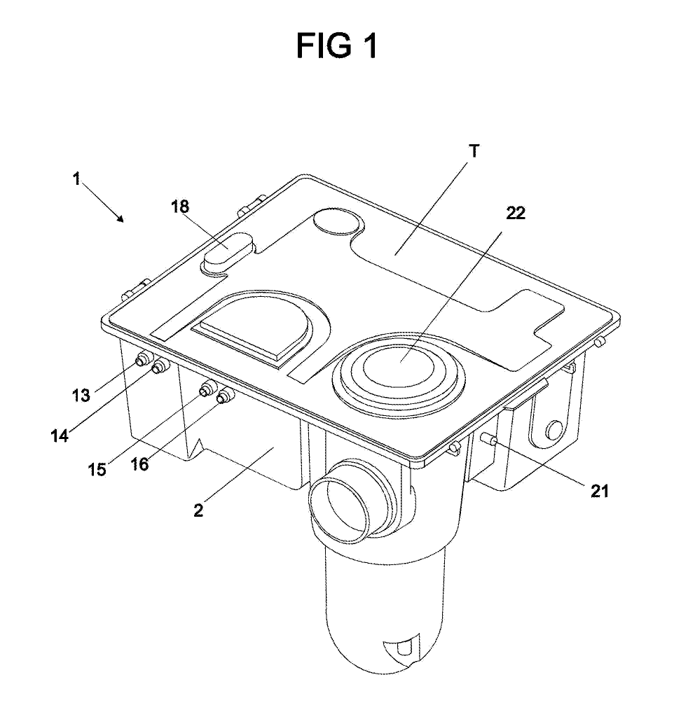

FIG. 2: View in exploded perspective of the multifunctional equipment for filtering pool water;

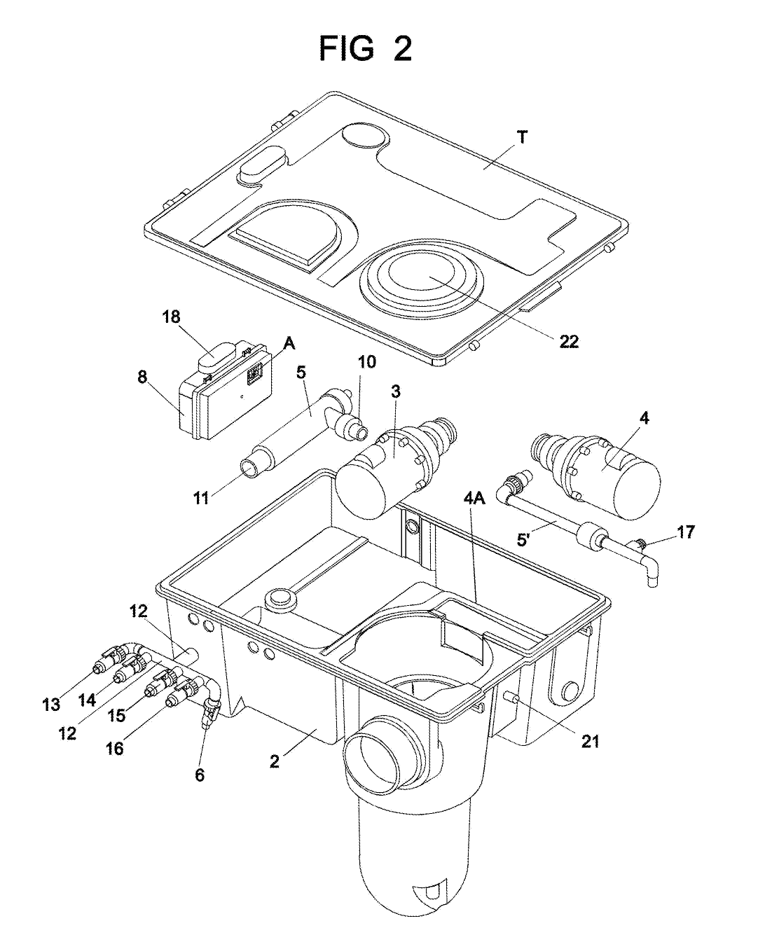

FIG. 3: View in interior perspective, showing the basic model of the multifunctional equipment for filtering pool water;

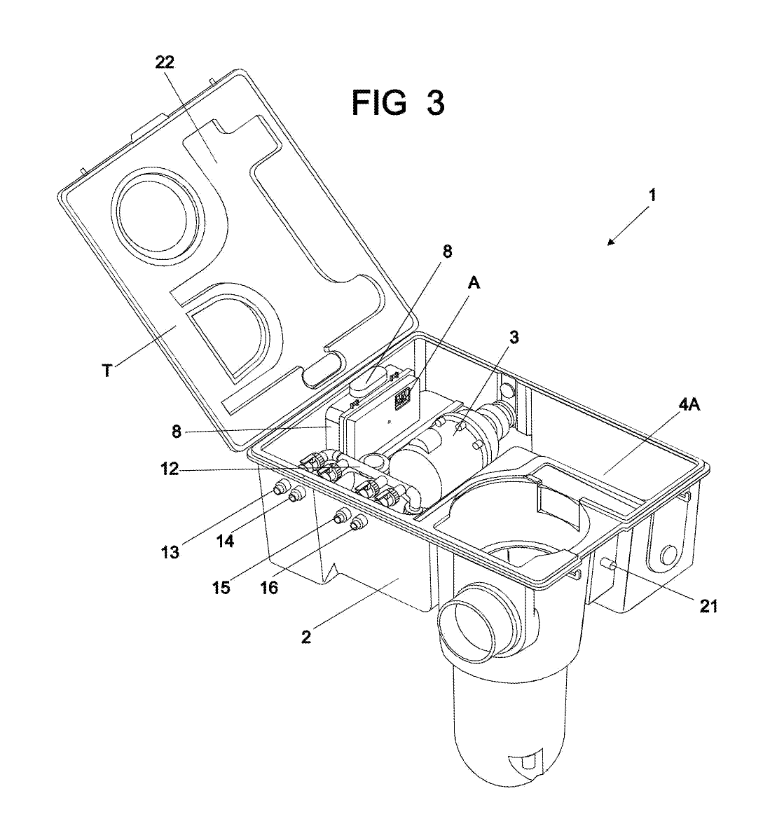

FIG. 4: View in interior perspective, showing the intermediary model of the multifunctional equipment for filtering pool water;

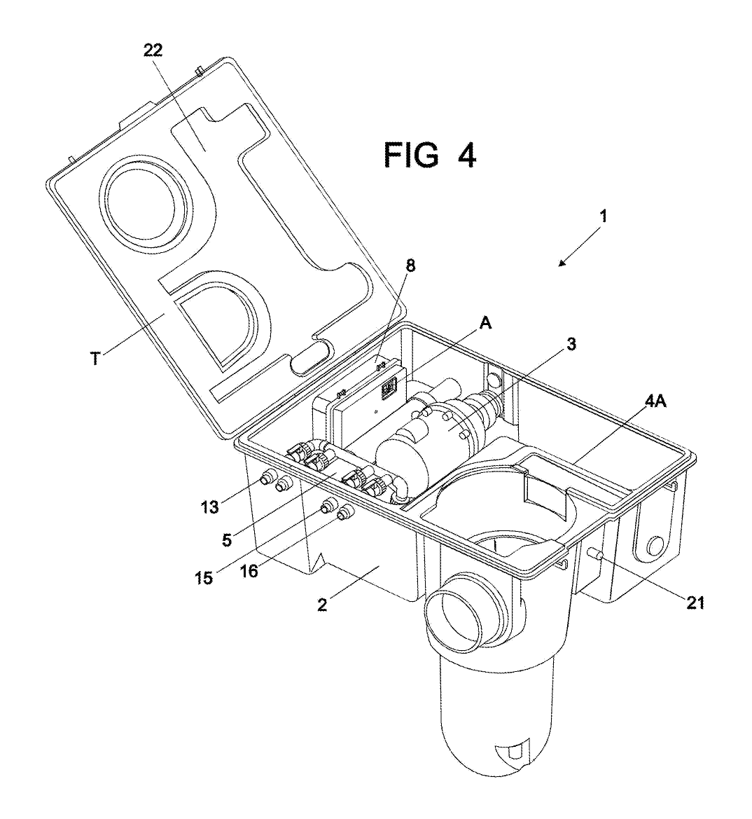

FIG. 5: View in interior perspective, showing the complete model of the multifunctional equipment for filtering pool water;

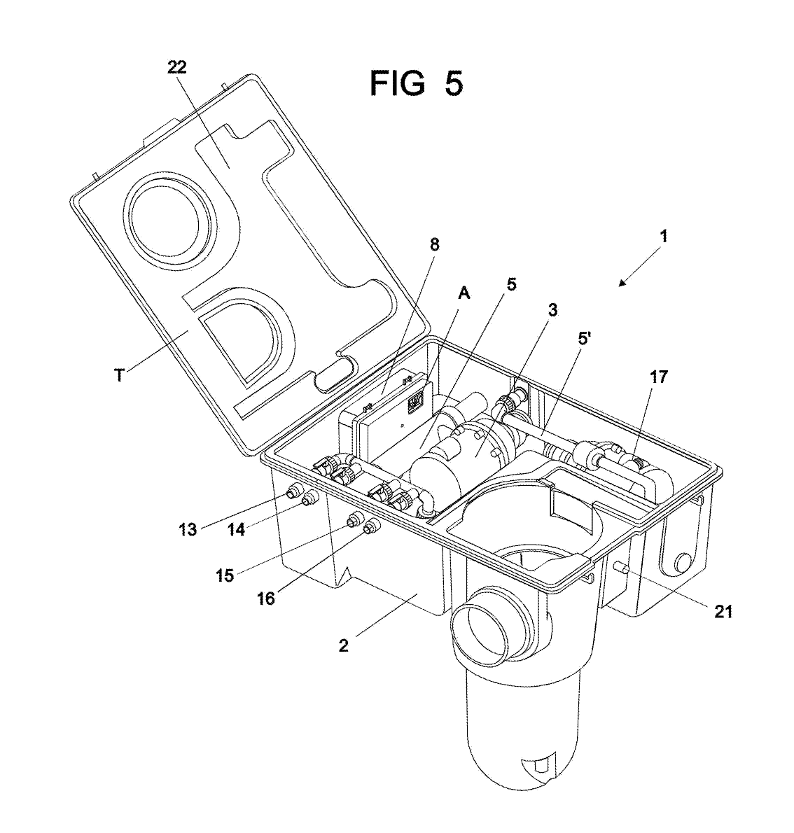

FIG. 6: Detail of a control box of the multifunctional equipment for filtering pool water.

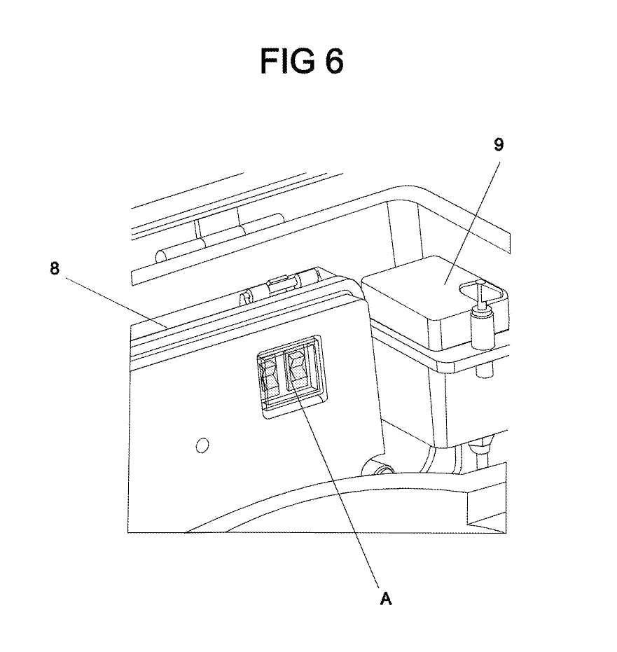

### DETAILED DESCRIPTION OF THE DRAWINGS

The “MULTIFUNCTIONAL EQUIPMENT FOR FILTERING POOL WATER”, object of this Utility Model request, consists by an equipment (1) to be used in swimming pools, composed by a box (2) with saddles to receive, immediately or later, besides main motor-pump (3), a motor-pump (4) for solar heating of water, filter with ultraviolet light (5), register (6) for cleaning with water pressurized by the equipment itself and optional register (7) for Scottish shower, for instance, besides an armored control box (8) with external activation (A).

More particularly, said equipment (1) stands out by allowing install equipments and components, originally or later, to add facilities to said equipment (1); for that, it is used an universal box (2) with saddles, registers and adequate interior spaces, all regulated by armored control box (8) with activation (A) having external buttons. The new equipment (1) has an interior area (4A), orthogonal to main motor-pump (3), destined to another motor-pump (4) linked to the system of water heating, solar heating preferentially, that by compatible tubing (5) recirculates the heated water in the pool. The control (9) of heated water circulation is made automatically by thermocouples strategically placed in the water flow with specific software that controls the exact moment for pumping, nothing prevents the manual activation. In the exit of main pump (3), it is a saddle (10) for connection of the filter with ultraviolet light (5), whose opposite extremity (11) is connected to the manifold (12) of the five registers (13, 14, 15, 16 and 17) existent in the equipment (1), thus enabling it to obtain a higher degree of quality in pool water filtration wherein the equipment (1) is installed. The whole operation and control of the new equipment is made by an armored control box (8) with led (18) used to help the interior vision of the box at night, with activation (A) by external buttons, not having need of an opening in the cover (T). Said box has also an electronic system of heating control with digital indicator. The equipment (1) still has a leveling float (20) that keeps the pool water level, avoiding the air suction and reducing the probability of fails in the suction mechanisms. The cover (T) of the equipment (1) has a vent (21) used to avoid the concentration of gases inside it, as well as the distention due to the interior heat. Said cover has also a visor (22) of inspection of the filter by percolating to identify the need of washing it, without the need of open the access cover.

What is claimed:

1. “MULTIFUNCTIONAL EQUIPMENT FOR FILTERING POOL WATER”, wherein it uses an universal box (2) with saddles, registers and adequate interior spaces, all regulated by armored control box (8) with activation having external buttons; the box has an interior area (4A) destined to a motor-pump (4) linked to the system of solar water heating that by compatible tubing (5) recirculates the heated water in the pool; the control (9) of heated water circulation is made automatically by thermocouples strategically placed in the water flow with specific software or manual activation; in the exit of main pump (3), it is a saddle (10) for connection of the filter with ultraviolet light (5), whose opposite extremity (11) is connected to the manifold (12) of the five registers (13, 14, 15, 16 and 17); besides the sewage register (13), drain register (14) and return register (15), the box (2) contains a register (16) for cleaning with pressurized water in the main motor-pump (3) and another register (17) with hot water outlet, since it is connected to the hot water tubing (5).
